(19) United States
(12) Patent Application Publication
(10) Pub. No.: US 2024/0411540 A1
(43) Pub. Date: Dec. 12, 2024

(54) METHOD FOR UPGRADING SOFTWARE SERVICES WITH UNIFIED DELIVERY

(71) Applicant: VMware, Inc., Palo Alto, CA (US)

(72) Inventors: Vikas Kumar PANDEY, Bangalore (IN); Sandeep SINHA, Bangalore (IN); Hakan Sunay HALIL, Sofia (BG); Ivaylo Radoslavov RADEV, Sofia (BG); Mark ZEREN, Newton, MA (US)

(21) Appl. No.: 18/330,947

(22) Filed: Jun. 7, 2023

(51) Int. Cl. G06F 8/65

(52) U.S. Cl. CPC G06F 8/65

(57) ABSTRACT

A method of upgrading a software service from a first version to a second version, wherein the software service is supported by a file system on which a first archive is mounted, includes the steps of: causing execution of the software service to be stopped, and mounting a second archive onto the file system, wherein the second mounted archive includes a plurality of files for executing the second version of the software service; creating a set of pointers, each of the set of pointers pointing to a respective one of the plurality of files of the second mounted archive; and after creating the set of pointers, causing the second version of the software service to be executed, wherein executing the second version of the software service involves accessing code from the plurality of files of the second mounted archive using the set of pointers and executing the code.

### BACKGROUND

In a software-defined data center (SDDC), virtual infrastructure (VI) is provisioned from hardware infrastructure. The VI includes virtual computing instances such as virtual machines (VMs) and containers, virtualized storage resources, and virtualized networking resources. The hardware infrastructure includes a plurality of host computers, referred to herein simply as hosts, and includes storage devices and networking devices. The provisioning of the VI is carried out by SDDC management software that is deployed, e.g., on virtual appliances or containers. Virtual appliances are pre-configured VMs, and containers are standalone units of software that each include one or more processes executing therein. For example, the SDDC management software may include a VMware vCenter Server® appliance and a VMware NSX® appliance, available from VMware, Inc.

The SDDC management software includes a plurality of software services, referred to herein simply as services, for managing the VI. For example, the services may include a database service, a lifecycle management service, and a single sign-on service. Developers regularly upgrade these services, releasing large upgrades to the services as major releases and small, incremental upgrades as minor releases. Developing and delivering such upgrades has become a slow and tedious process as different types of releases (major and minor) are supported, and as different implementations of SDDC management software (e.g., as virtual appliances or as containers) are increasingly supported. This is due in part to the use of a variety of different formats for the different types of upgrades. For example, major releases for virtual appliances may be delivered in open virtual appliance (OVA) packages, while minor releases are delivered in RPM package manager (RPM) packages. Upgrades to SDDC management software for different implementations (e.g., as containers) may use different formats yet. Developers must thus build and test upgrades in a variety of formats, which is time-consuming and expensive.

Furthermore, installing upgrades is a time-consuming process involving copying large amounts of data into various parts of a file system. All that copying saturates the input- output (I/O) bandwidth of the hardware infrastructure supporting the SDDC management software, which creates issues for both developers and customers. For developers, long installations result in longer builds and slower tests, thus increasing the cost and time for developing upgrades to services. For customers, long installations result in longer downtime for the SDDCs as the customers wait for services to be upgraded. Such downtime is exacerbated when an upgrade fails, and the customer must roll back a service to an earlier version, which may be complicated and require the customer to manually undo changes made by the failed upgrade. A method of upgrading SDDC management software is desired that reduces the time and cost of developing upgrades to services and that reduces the downtime for SDDCs.

### SUMMARY

One or more embodiments provide a method of upgrading a first software service from a first version to a second version, wherein the first software service is supported by a file system on which a first archive is mounted, the first mounted archive including a plurality of files for executing the first version of the first software service. The method includes the steps of: stopping execution of the first software service, and mounting a second archive onto the file system, wherein the second mounted archive includes a plurality of files for executing the second version of the first software service; creating a first set of pointers, each of the first set of pointers pointing to a respective one of the plurality of files of the second mounted archive; and after creating the first set of pointers, executing the second version of the first software service by accessing first code from the plurality of files of the second mounted archive using the first set of pointers and executing the first code.

Further embodiments include a non-transitory computer-readable storage medium comprising instructions that cause a computer system to carry out the above method, as well as an upgrade orchestrator configured to carry out the above method.

### BRIEF DESCRIPTION OF THE DRAWINGS

FIG. 1 is a block diagram of an image depot and an SDDC in which a first embodiment may be implemented.

FIG. 2 is a block diagram of the image depot and an SDDC in which a second embodiment may be implemented.

FIG. 3 is a block diagram of a file system used by SDDC management software, according to embodiments.

FIG. 4 is a flow diagram of a method performed by an upgrade orchestrator of an SDDC to upgrade one or more services of SDDC management software according to inter-service dependencies, according to embodiments.

FIG. 5 is a flow diagram of a method performed by the upgrade orchestrator to upgrade a single service, according to embodiments.

FIG. 6 is a flow diagram of a method performed by the upgrade orchestrator to create symbolic links for executing an upgraded service, according to embodiments.

FIG. 7 is a flow diagram of a method performed by the upgrade orchestrator to roll back a service to an earlier version, according to embodiments.

### DETAILED DESCRIPTION

Techniques for upgrading SDDC management software are described. According to techniques, upgrades to services of the SDDC management software are all delivered as archive files such as tarballs. The same archive file format is used regardless of what type of release the upgrade is (major or minor) and regardless of how the SDDC management software is implemented (e.g., as a virtual appliance or as containers). Delivery of upgrades is thus unified, which saves time and cost for developing the upgrades because developers must only build and test upgrades in a single format.

The SDDC management software is implemented either as a virtual appliance or as a group of containers, each container executing a service. In both implementations, the SDDC management software utilizes a read-only file system. To execute a service, an archive for the service is mounted on the file system, and pointers such as symbolic links are created that point to files of the archive. The virtual appliance (or a container) then executes the service by using the symbolic links to access code from the files and then executing the code. To upgrade a service to a new version, a new archive is downloaded that includes files for the upgraded version, and the new archive is mounted on the file system. The execution of the service is then stopped, pointers to the earlier archive are deleted, and new pointers are created to files of the new archive. The virtual appliance (or a container) then executes the upgraded version using the new symbolic links.

The downtime for upgrading a service is largely spent creating symbolic links to the files of a new archive. Other services referencing the upgraded service remain unchanged, their references to symbolic links of the upgraded service still working. The downtime of the upgraded service is thus proportional to the number of files in the new archive. This is significantly shorter than the downtime for installing software packages. For installation, unlike the techniques described herein, the downtime is spent copying files into a file system, the downtime thus being proportional to the sizes of installation packages. Furthermore, as with the upgrade workflow, techniques described herein reduce build and test time for developers. Developers build and test upgrades without installation, the build and test time for a service thus also being proportional to a number of files instead of a size of a package.

To roll back a service to an earlier version, the execution of the service is stopped, pointers to a new archive are deleted, and pointers to an earlier archive are created. Such rolling back is relatively fast and simple, and may be handled automatically if an error is detected in the upgrading of a service. The customer is thus not forced to manually undo changes made by a failed upgrade. These and further aspects of the invention are discussed below with respect to the drawings.

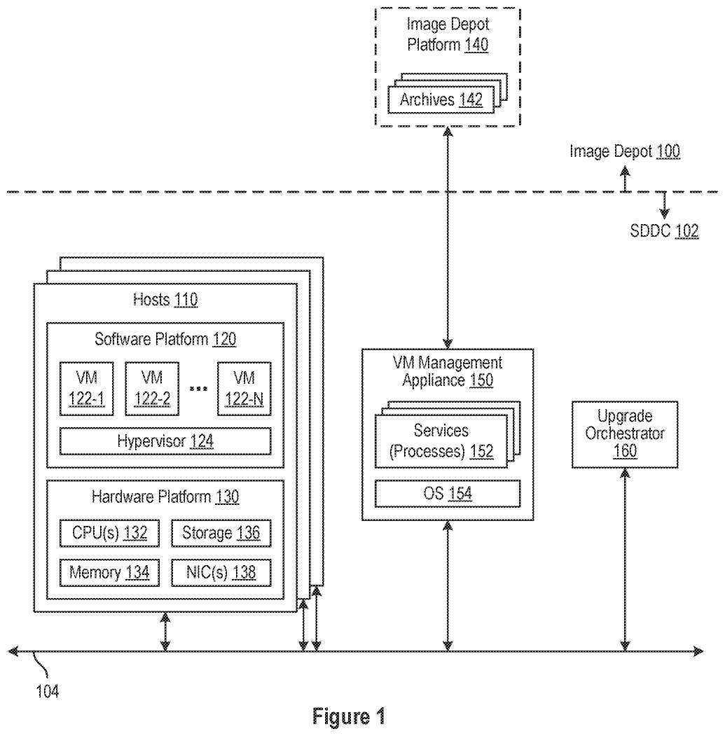

FIG. 1 is a block diagram of an image depot 100 and an SDDC 102 in which a first embodiment may be implemented. SDDC 102 is managed by/for an organization, the organization also referred to herein as a “customer.” SDDC 102 may be in an on-premise data center managed by the customer, a private cloud managed by the customer, a public cloud managed for the customer by another organization, or any combination of these. In addition, the customer may have other SDDCs (not shown), and the customer's SDDCs may be deployed in a hybrid manner, e.g., on-premise, in a private cloud, in a public cloud, and/or as a service, and across different geographical regions. Image depot 100 is illustrated as being remote from SDDC 102, e.g., in a separate data center. However, image depot 100 may also be local.

SDDC 102 includes a cluster of hosts 110, SDDC management software such as a VM management appliance 150, and an upgrade orchestrator 160. Each of hosts 110 is constructed on a hardware platform 130 such as an x86 architecture platform. Hardware platform 130 includes conventional components of a computing device, such as one or more central processing units (CPUs) 132, memory 134 such as random-access memory (RAM), local storage 136 such as one or more magnetic drives or solid-state drives (SSDs), and one or more network interface cards (NICs) 138. CPU(s) 132 are configured to execute instructions such as executable instructions that perform one or more operations described herein, which may be stored in memory 134. Local storage 136 of hosts 110 may optionally be aggregated and provisioned as a virtual storage arca network (vSAN). NICs 138 enable hosts 110 to communicate with each other and with other devices over a network 104 such as a local area network (LAN).

Hardware platform 130 of each of hosts 110 supports a software platform 120. Software platform 120 includes a hypervisor 124, which is a virtualization software layer. Hypervisor 124 supports a VM execution space within which VMs 122 are concurrently instantiated and executed. One or more applications of the customer run in VMs 122. One example of hypervisor 124 is a VMware ESX® hypervisor, available from VMware, Inc.

According to the first embodiment, the SDDC management software is implemented as virtual appliances, including VM management appliance 150, for overall management of VI. VM management appliance 150 logically groups hosts 110 into a cluster to perform cluster-level tasks such as provisioning and managing VMs 122 and migrating VMs 122 from one of hosts 110 to another. VM management appliance 150 communicates with hosts 110 via a management network (not shown) provisioned from network 104. One example of VM management appliance 150 is a VMware vCenter Server® appliance, available from VMware, Inc. There are also other virtual appliances (not shown) such as a network management appliance (e.g., a VMware NSX® appliance, available from VMware, Inc.) for management of virtual networks. Each of the virtual appliances is a pre-configured VM, e.g., one of VMs 122.

VM management appliance 150 includes a plurality of services 152, each of services 152 executing as one or more processes. For example, a database service manages an inventory of objects for hosts 110 such as VMs 122 and virtual compute, storage, and networking resources thereof. A lifecycle management (LCM) service delivers various lifecycle functionalities such as storing a desired state of hypervisor 124 and, when the running state of hypervisor 124 differs from its desired state, remediating hypervisor 124 to its desired state. A single sign-on (SSO) service implements a platform for authenticating administrators of the customer based on privileges and roles, privileges being fine-grained access controls, and each role being a set of one or more privileges. According to embodiments, each of services 152 is executed based on an archive such as a tarball, the archive being mounted on a read-only file system (not shown in FIG. 1) of a guest operating system (OS) 154.

Upgrade orchestrator 160 orchestrates the upgrading of services 152, as discussed below. Upgrade orchestrator 160 may execute as a process of VM management appliance 150. Upgrade orchestrator 160 may alternatively execute as a process of a separate one of VMs 122. Image depot platform 140 is a computing platform that centrally stores released versions of services 152, each released version corresponding to one of archives 142. For example, each of archives 142 may be a tarball that includes a binary file for executing a version of one of services 152 and pre-defined configurations therefor.

VM management appliance 150 acquires archives 142 from image depot platform 140 to mount onto OS 154, for both major and minor releases. For example, image depot platform 140 may execute on a computing platform of a public cloud, in which case VM management appliance 150 downloads archives 142, e.g., via the Internet. As another example, image depot platform 140 may reside locally to VM management appliance 150, in which case image depot platform 140 transmits archives 142 to VM management appliance 150 over a private network, e.g., network 104. Once mounted, VM management appliance 150 executes versions of services 152 by using pointers such as symbolic links to access files of archives 142, as discussed below.

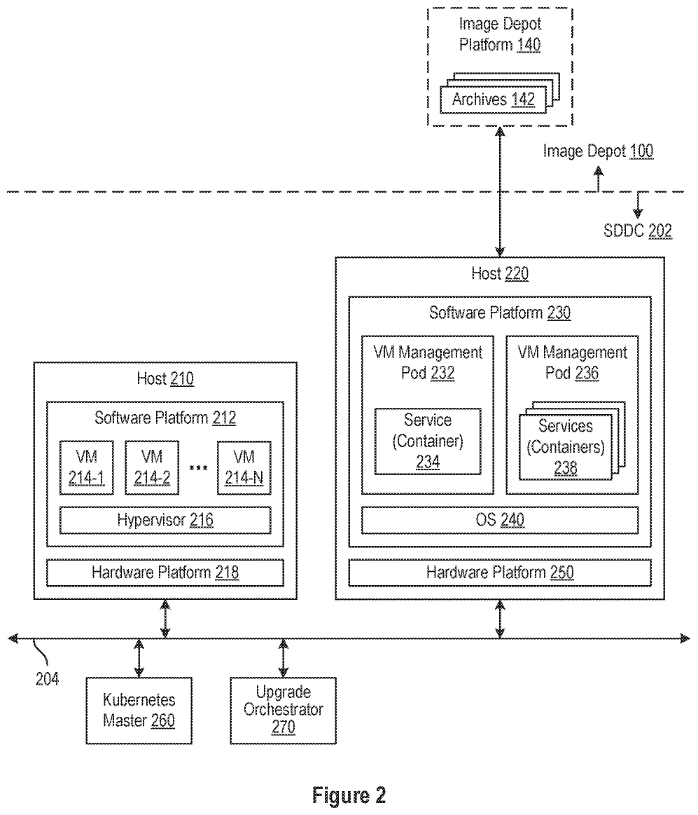

FIG. 2 is a block diagram of image depot 100 and an SDDC 202 in which a second embodiment may be implemented. According to the second embodiment, the VM management software executes as containers instead of virtual appliances. In the example of FIG. 2, the VM management software is deployed on a Kubernetes® platform. However, the VM management software may be deployed on other container platforms. It should be noted that the same image depot 100, image depot platform 140, and archives 142 are used in the first and second embodiments. The delivery of upgrades to services of VM management software is unified.

Like SDDC 102, SDDC 202 is managed by/for the customer and may be in an on-premise data center managed by the customer, a private cloud managed by the customer, a public cloud managed for the customer by another organization, or any combination of these. SDDC 202 includes hosts 210 and 220, a Kubernetes master 260, and an upgrade orchestrator 270. Host 210 is constructed on a hardware platform 218 such as an x86 architecture platform. Hardware platform 218 includes the conventional components of a computing device (not shown) discussed above with respect to hardware platform 130, including one or more NICs for communicating with other devices over a network 204 such as a LAN. Hardware platform 218 supports a software platform 212. Software platform 212 includes a hypervisor 216, which is a virtualization software layer. Hypervisor 216 supports a VM execution space within which VMs 214 are concurrently instantiated and executed. One or more applications of the customer run in VMs 214.

Host 220 is constructed on a hardware platform 250 such as an x86 architecture platform. Hardware platform 250 includes the conventional components of a computing device (not shown) discussed above with respect to hardware platform 130. The components include one or more CPUs that are configured to execute instructions such as executable instructions that perform one or more operations described herein, which may be stored in memory of hardware platform 250. The components further include one or more NICs, which enable host 220 to communicate with other devices over network 204. Hardware platform 250 supports a software platform 230. Software platform 230 includes an OS 240 supporting VM management pods 232 and 236. VM management pod 232 includes a service 234 executing as a container, and VM management pod 236 includes services 238, each of services 238 executing as a container. For example, services 234 and 238 may include a database service, an LCM service, and an SSO service, each performing functionalities for managing VMs 214.

Kubernetes master 260 orchestrates the deployment and state management of containers of host 220. For example, if the containers are Docker® containers, Kubernetes master 260 deploys containers built using Dockerfiles. Kubernetes master 260 also continuously monitors the state of the containers of host 220 and, if the actual state deviates from a desired state specified in a file (e.g., a YAML file), Kubernetes master 260 upgrades the actual state to match the desired state. Kubernetes master 260 may be, e.g., a VM executing on one of hosts 210 and 220.

Similar to upgrade orchestrator 160 of FIG. 1, upgrade orchestrator 270 orchestrates the upgrading of services 234 and 238. Upgrade orchestrator 270 may be, e.g., one or more processes executing on software platform 230. Host 220 acquires archives 142 from image depot platform 140 to mount onto OS 240, for both major and minor releases. For example, depending on where image platform 140 resides, host 220 may download archives 142 via the Internet or acquire archives 142 over a private network such as network 204. Once mounted, VM management pods 232 and 236 execute versions of services 234 and 238 by using pointers such as symbolic links to access files of archives 142, as discussed below.

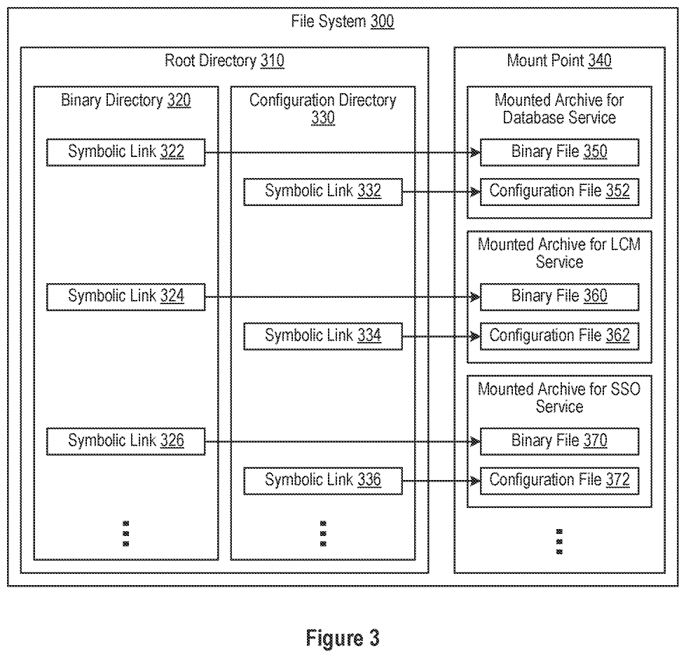

FIG. 3 is a block diagram of a read-only file system 300 used by SDDC management software, according to embodiments. For example, file system 300 may be a file system of OS 154 of FIG. 1 or a file system of OS 240 of FIG. 2. File system 300 includes a root directory 310 and a mount point 340. Root directory 310 is a top-most directory in a file hierarchy of file system 300. Mount point 340 is a location of file system 300 at which services are mounted. Root directory 310 contains two subdirectories, a binary directory 320 and a configuration directory 330.

Binary directory 320 includes symbolic links to binary files of services. The binary files include executable code for running services of the SDDC management software (e.g., object code generated from compiled C++ code). Configuration directory 330 includes symbolic links to configuration files (e.g., XML files) of services. The configuration files include human-readable configurations for the services. The binary files are immutable, whereas the customer may update configurations of the configuration files. Each symbolic link is a file storing a name of a respective binary or configuration file, including a file path thereto. Although only one directory is illustrated for storing symbolic links to configurations files, there may instead be a separate directory for each service for such symbolic links.

For simplicity of illustration, FIG. 3 includes mounted archives for three services: a database service, an LCM service, and an SSO service. However, in practice, the SDDC management software includes many more services. The mounted archive for the database service includes a binary file 350 and a configuration file 352. The mounted archive for the LCM service includes a binary file 360 and a configuration file 362. The mounted archive for the SSO service includes a binary file 370 and a configuration file 372. Binary directory 320 includes symbolic links 322, 324, and 326 pointing to binary files 350, 360, and 370, respectively. Configuration directory 330 includes symbolic links 332. 334, and 336 pointing to configuration files 352, 362, and 372, respectively. It should be noted that as long as symbolic links are used, file system 300 may be of a different type, e.g., fourth extended file system (ext4), than that of the mounted archives, e.g., tar file system (TarFS).

For example, according to the first embodiment, VM management appliance 150 executes the database service by using symbolic links 322 and 332 to access binary file 350 and configuration file 352, respectively. VM management appliance 150 then executes the code of binary file 350 and applies configurations from configuration file 352. Similarly, VM management appliance 150 executes the LCM service by using symbolic links 324 and 334 to access and execute binary file 360 and to access and apply configuration file 362. VM management appliance 150 executes the SSO service by using symbolic links 326 and 336 to access and execute binary file 370 and to access and apply configuration file 372. Similarly, according to the second embodiment, respective pods use the symbolic links to access and execute binary files 350, 360, and 370 and to access and apply configuration files 352, 362, and 372.

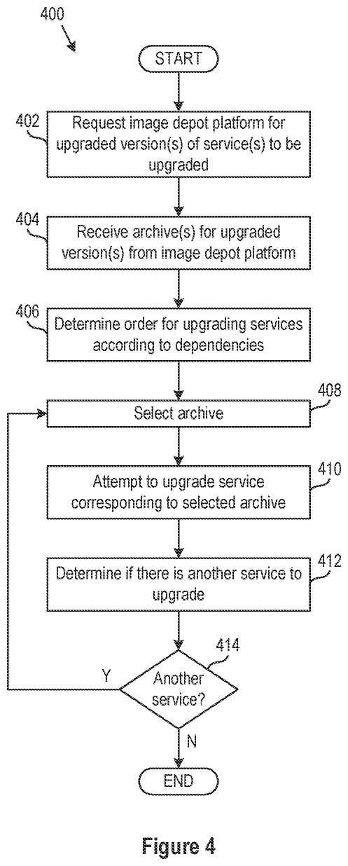

FIG. 4 is a flow diagram of a method 400 performed by an upgrade orchestrator (upgrade orchestrator 160 of FIG. 1 or upgrade orchestrator 270 of FIG. 2) to upgrade one or more services of SDDC management software according to inter-service dependencies, according to embodiments. For example, the one or more services may be upgraded automatically at a predetermined time according to a service-level agreement. Some services of the SDDC management software have dependencies on other services. Accordingly, the upgrade orchestrator maintains a list of such dependencies for when a plurality of services are to be upgraded. For example, if a first service to be upgraded is dependent on a second service to be upgraded, the upgrade orchestrator upgrades the second service first.

At step 402, the upgrade orchestrator requests image depot platform 140 for an upgraded version(s) of the one or more services to be upgraded. At step 404, the upgrade orchestrator receives an upgraded archive(s) for the upgraded version(s) from image depot platform 140, e.g., over the Internet or over a LAN. At step 406, the upgrade orchestrator determines an order for upgrading services corresponding to the received archives according to dependencies therebetween (if more than one archive is received at step 404). At step 408, the upgrade orchestrator selects an archive according to the determined order.

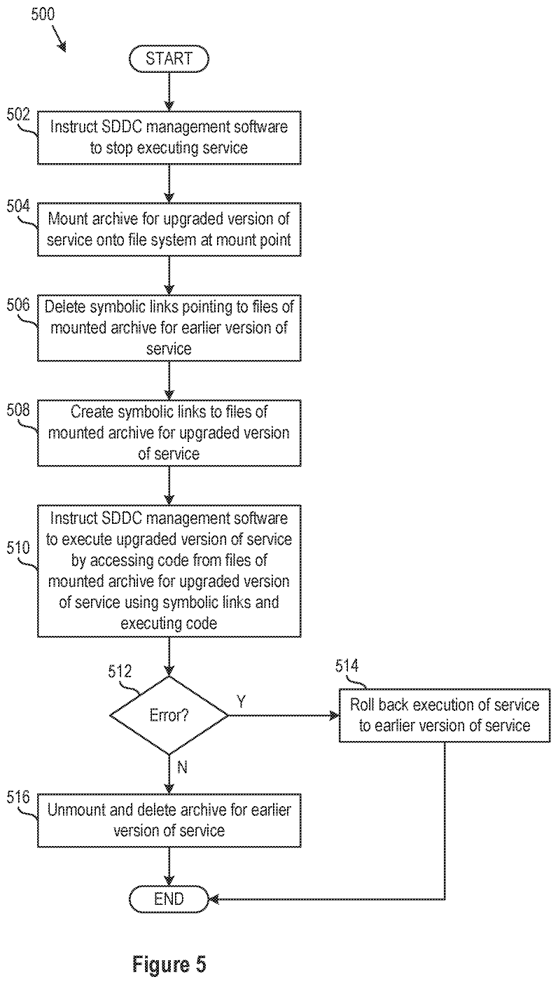

At step 410, the upgrade orchestrator attempts to upgrade the service corresponding to the selected archive, as discussed below in conjunction with FIG. 5. At step 412, the upgrade orchestrator determines if there is another service to be upgraded. At step 414, if there is another service to be upgraded, method 400 returns to step 408, and the upgrade orchestrator selects the next archive. Otherwise, if there is not another service to be upgraded, method 400 ends.

FIG. 5 is a flow diagram of a method performed by an upgrade orchestrator (upgrade orchestrator 160 of FIG. 1 or upgrade orchestrator 270 of FIG. 2) to upgrade a single service, according to embodiments. At step 502, the upgrade orchestrator instructs the SDDC management software (VM management appliance 150 of FIG. 1 or a VM management pod of FIG. 2) to stop the executing the service. At step 504, the upgrade orchestrator mounts an archive of an upgraded version of the service onto file system 300 at mount point 340. At step 506, the upgrade orchestrator deletes symbolic links that are pointing to files of a previously mounted archive for an earlier version of the service.

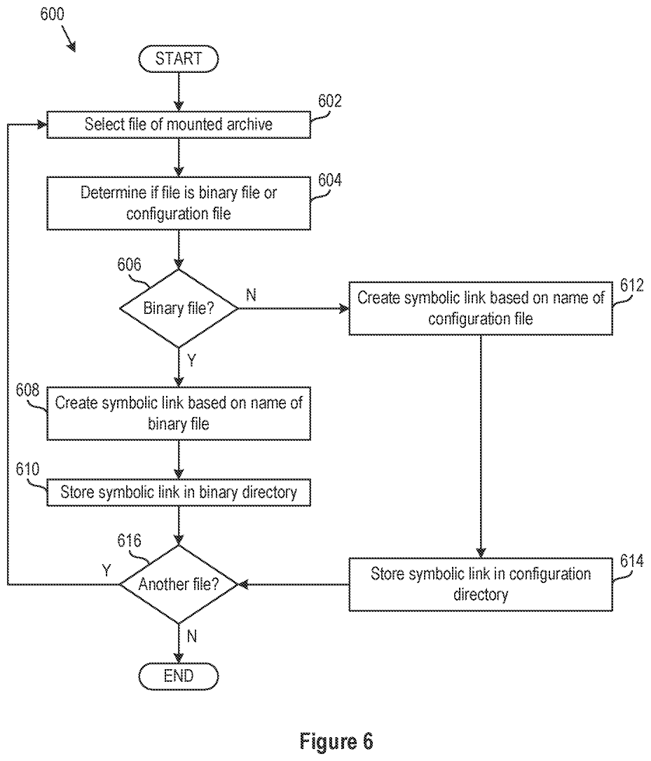

At step 508, the upgrade orchestrator creates symbolic links pointing to files of the mounted archive for the upgraded version of the service, as discussed below in conjunction with FIG. 6. The symbolic links include a symbolic link pointing to a binary file of the archive and a symbolic link pointing to a configuration file of the archive. At step 510, the upgrade orchestrator instructs the SDDC management software to execute the upgraded version of the service. The SDDC management software executes the upgraded version by accessing code from files of the mounted archive for the upgraded version of the service by using the symbolic links and then executing the code. More specifically, the SDDC management software executes code from a binary file and applies configurations from a configuration file.

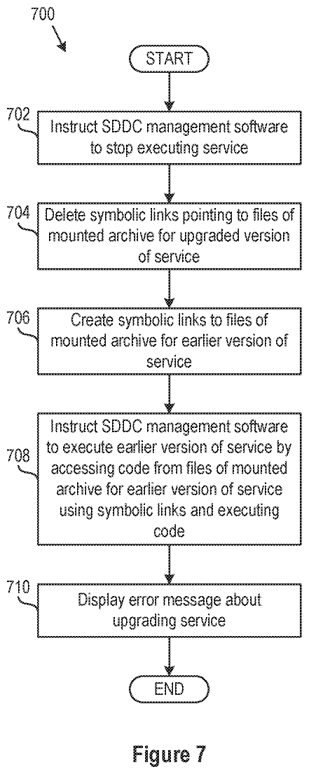

At step 512, if an error is detected in executing the upgraded version of the service, method 500 moves to step 514. At step 514, the upgrade orchestrator rolls back the version of the service, as discussed below in conjunction with FIG. 7. After step 514, method 500 ends. Returning to step 512, if no error is detected, method 500 moves to step 516. At step 516, the upgrade orchestrator unmounts the archive for the earlier version of the service from file system 300 and deletes the archive. It should be noted that other services may reference the service that has been upgraded, such other services referencing symbolic links of the upgraded service. If the new symbolic links created at step 508 have the same names as the old symbolic links deleted at step 506, the references of those other services need not be updated. In other words, the references to the symbolic links still work even though the symbolic links now point to a different archive. After step 516, method 500 ends.

FIG. 6 is a flow diagram of a method 600 performed by an upgrade orchestrator (upgrade orchestrator 160 of FIG. 1 or upgrade orchestrator 270 of FIG. 2) to create symbolic links for executing an upgraded service, according to embodiments. At step 602, the upgrade orchestrator selects a file of a mounted archive corresponding to the upgraded service. At step 604, the upgrade orchestrator determines if the file is a binary file or a configuration file, e.g., based on an extension of the file. At step 606, if the file is a binary file, method 600 moves to step 608. At step 608, the upgrade orchestrator creates a symbolic link based on the name of the binary file (and file path thereto). At step 610, the upgrade orchestrator stores the symbolic link in binary directory 320 of file system 300.

Returning to step 606, if the file is a configuration file, method 600 moves to step 612. At step 612, the upgrade orchestrator creates a symbolic link based on the name of the configuration file (and a file path thereto). At step 614, the upgrade orchestrator stores the symbolic link in configuration directory 330 of file system 300. At step 616, if there is another file in the mounted archive to create a symbolic link for, method 600 returns to step 602, and the upgrade orchestrator selects another file. Otherwise, if there are no more files in the mounted archive to create symbolic links for, method 600 ends.

FIG. 7 is a flow diagram of a method 700 performed by an upgrade orchestrator (upgrade orchestrator 160 of FIG. 1 or upgrade orchestrator 270 of FIG. 2) to roll back a service to an earlier version, according to embodiments. At step 702, the upgrade orchestrator instructs the SDDC management software (VM management appliance 150 of FIG. 1 or a VM management pod of FIG. 2) to stop the executing the service. At step 704, the upgrade orchestrator deletes symbolic links that are pointing to files of a previously mounted archive for an upgraded version of the service. At step 706, the upgrade orchestrator creates symbolic links pointing to files of the mounted archive for the earlier version of the service, as discussed above in conjunction with FIG. 6.

At step 708, the upgrade orchestrator instructs the SDDC management software to execute the earlier version of the service. The SDDC management software executes the earlier version by accessing code from files of the mounted archive for the earlier version of the service by using the symbolic links and then executing the code. At step 710, the upgrade orchestrator displays an error message to an administrator that the service could not be upgraded. After step 710, method 700 ends.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are magnetic drives, SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest OS that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of upgrading a first software service from a first version to a second version, wherein the first software service is supported by a file system on which a first archive is mounted, the first mounted archive including a plurality of files for executing the first version of the first software service, the method comprising:
causing execution of the first software service to be stopped, and mounting a second archive onto the file system, wherein the second mounted archive includes a plurality of files for executing the second version of the first software service;
creating a first set of pointers, each of the first set of pointers pointing to a respective one of the plurality of files of the second mounted archive; and
after creating the first set of pointers, causing the second version of the first software service to be executed, wherein executing the second version of the first software service involves accessing first code from the plurality of files of the second mounted archive using the first set of pointers and executing the first code.

2. The method of claim 1, wherein the second version of the first software service and a plurality of other software services are executed in a virtual appliance.

3. The method of claim 1, wherein the second version of the first software service is executed in a container.

4. The method of claim 1, wherein the first and second mounted archives are tarballs, the plurality of files for executing the first version of the first software service including a first executable binary file and a first human-readable configuration file, and the plurality of files for executing the second version of the first software service including a second executable binary file and a second human-readable configuration file.

5. The method of claim 4, wherein the first set of pointers includes a first symbolic link that points to the second executable binary file and a second symbolic link that points to the second human-readable configuration file.

6. The method of claim 1, further comprising:
detecting an error in execution of the second version of the first software service; and
in response to detecting the error:
causing execution of the first software service to be stopped;
creating a second set of pointers, each of the second set of pointers pointing to a respective one of the plurality of files of the first mounted archive; and
after creating the second set of pointers, causing the first version of the first software service to be executed, wherein executing the first version of the first software service involves accessing second code from the plurality of files of the first mounted archive using the second set of pointers and executing the second code.

7. The method of claim 1, further comprising:
determining that the first software service has a dependency on a second software service; and
based on determining that the first software service has the dependency, performing the following steps before causing the second version of the first software service to be executed:
causing execution of the second software service to be stopped, and mounting a third archive onto the file system, wherein the third mounted archive includes a plurality of files for executing an upgraded version of the second software service;
creating a second set of pointers, each of the second set of pointers pointing to a respective one of the plurality of files of the third mounted archive; and
after creating the second set of pointers, causing the upgraded version of the second software service to be executed, wherein executing the upgraded version of the second software service involves accessing second code from the plurality of files of the third mounted archive using the second set of pointers and executing the second code.

8. A non-transitory computer-readable medium comprising instructions that are executable in a computer system, wherein the instructions when executed cause the computer system to carry out a method of upgrading a first software service from a first version to a second version, wherein the first software service is supported by a read-only file system on which a first archive is mounted, the first mounted archive including a plurality of files for executing the first version of the first software service, the method comprising:
causing execution of the first software service to be stopped, and mounting a second archive onto the read-only file system, wherein the second mounted archive includes a plurality of files for executing the second version of the first software service;
creating a first set of pointers, each of the first set of pointers pointing to a respective one of the plurality of files of the second mounted archive; and
after creating the first set of pointers, causing the second version of the first software service to be executed, wherein executing the second version of the first software service involves accessing first code from the plurality of files of the second mounted archive using the first set of pointers and executing the first code.

9. The non-transitory computer-readable medium of claim 8, wherein the second version of the first software service and a plurality of other software services are executed in a virtual appliance.

10. The non-transitory computer-readable medium of claim 8, wherein the second version of the first software service is executed in a container.

11. The non-transitory computer-readable medium of claim 8, wherein the first and second mounted archives are tarballs, the plurality of files for executing the first version of the first software service including a first executable binary file and a first human-readable configuration file, and the plurality of files for executing the second version of the first software service including a second executable binary file and a second human-readable configuration file.

12. The non-transitory computer-readable medium of claim 11, wherein the first set of pointers includes a first symbolic link that points to the second executable binary file and a second symbolic link that points to the second human-readable configuration file.

13. The non-transitory computer-readable medium of claim 8, wherein the method further comprises:
detecting an error in execution of the second version of the first software service; and
in response to detecting the error:
causing execution of the first software service to be stopped;
creating a second set of pointers, each of the second set of pointers pointing to a respective one of the plurality of files of the first mounted archive; and
after creating the second set of pointers, causing the first version of the first software service to be executed, wherein executing the first version of the first software service involves accessing second code from the plurality of files of the first mounted archive using the second set of pointers and executing the second code.

14. The non-transitory computer-readable medium of claim 8, wherein the method further comprises:
determining that the first software service has a dependency on a second software service; and
based on determining that the first software service has the dependency, performing the following steps before causing the second version of the first software service to be executed:
causing execution of the second software service to be stopped, and mounting a third archive onto the file system, wherein the third mounted archive includes a plurality of files for executing an upgraded version of the second software service;
creating a second set of pointers, each of the second set of pointers pointing to a respective one of the plurality of files of the third mounted archive; and
after creating the second set of pointers, causing the upgraded version of the second software service to be executed, wherein executing the upgraded version of the second software service involves accessing second code from the plurality of files of the third mounted archive using the second set of pointers and executing the second code.

15. An upgrade orchestrator configured to execute on a processor of a hardware platform to upgrade a first software service from a first version to a second version, wherein the first software service is supported by a file system on which a first archive is mounted, the first mounted archive including a plurality of files for executing the first version of the first software service, and wherein to upgrade the first software service, the upgrade orchestrator is configured to:
instruct SDDC management software to stop executing the first software service;
mount a second archive onto the file system, wherein the second mounted archive includes a plurality of files for executing the second version of the first software service;
create a first set of pointers, each of the first set of pointers pointing to a respective one of the plurality of files of the second mounted archive; and
after creating the first set of pointers, instruct the SDDC management software to execute the second version of the first software service, wherein executing the second version of the first software service involves accessing first code from the plurality of files of the second mounted archive using the first set of pointers and executing the first code.

16. The upgrade orchestrator of claim 15, wherein the second version of the first software service and a plurality of other software services are executed in a virtual appliance.

17. The upgrade orchestrator of claim 15, wherein the second version of the first software service is executed in a container.

18. The upgrade orchestrator of claim 15,
wherein the first and second mounted archives are tarballs, the plurality of files for executing the first version of the first software service including a first executable binary file and a first human-readable configuration file, and the plurality of files for executing the second version of the first software service including a second executable binary file and a second human-readable configuration file, and
wherein the first set of pointers includes a first symbolic link that points to the second executable binary file and a second symbolic link that points to the second human-readable configuration file.

19. The upgrade orchestrator of claim 15, further configured to:
detect an error in execution of the second version of the first software service; and
in response to detecting the error:
instruct the SDDC management software to stop executing the first software service;
create a second set of pointers, each of the second set of pointers pointing to a respective one of the plurality of files of the first mounted archive; and
after creating the second set of pointers, instruct the SDDC management software to execute the first version of the first software service, wherein executing the first version of the first software service involves accessing second code from the plurality of files of the first mounted archive using the second set of pointers and executing the second code.

20. The upgrade orchestrator of claim 15, further configured to:
determine that the first software service has a dependency on a second software service; and
based on determining that the first software service has the dependency, perform the following steps before causing the second version of the first software service to be executed:
instruct the SDDC management software to stop executing the second software service;
mount a third archive onto the file system, wherein the third mounted archive includes a plurality of files for executing an upgraded version of the second software service;
create a second set of pointers, each of the second set of pointers pointing to a respective one of the plurality of files of the third mounted archive; and
after creating the second set of pointers, instruct the SDDC management software to execute the upgraded version of the second software service, wherein executing the upgraded version of the second software service involves accessing second code from the plurality of files of the third mounted archive using the second set of pointers and executing the second code.
